(19) United States
(12) Patent Application Publication
(10) Pub. No.: US 2023/0306716 A1
(43) Pub. Date: Sep. 28, 2023

(54) VEHICLE CLASSIFICATION DEVICE AND SYSTEM USING IMAGE ANALYSIS, AND METHOD THEREFOR

(71) Applicant: REXGEN CO., LTD., Anyang-si (KR)

(72) Inventor: Soonhyun AHN, Anyang-si (KR)

(73) Assignee: REXGEN CO., LTD., Anyang-si (KR)

(21) Appl. No.: 18/040,987

(22) PCT Filed: Apr. 12, 2021
(86) PCT No.: PCT/KR2021/004546

§ 371 Date: Feb. 8, 2023

(30) Foreign Application Priority Data
Sep. 8, 2020 (KR) 10-2020-0114933

(51) Int. Cl. G06V 10/764; G06V 20/62; G06V 10/774

(52) U.S. Cl. CPC G06V 10/764; G06V 20/625; G06V 10/774; G06V 2201/08

(57) ABSTRACT

A vehicle classification device using an image analysis, according to one embodiment of the present invention, is presented. The device comprises: an image acquisition unit for acquiring a vehicle image including a license plate; a vehicle information acquisition unit for extracting vehicle identification information from the acquired vehicle image; a registration information acquisition unit for acquiring vehicle registration information corresponding to the vehicle identification information; a control unit which allocates a classification key by selectively extracting some of the vehicle registration information indicating external characteristics of a vehicle, and which classifies the vehicle image according to the classification key; and a learning processing unit using the classification key to learn the vehicle image.

### TECHNICAL FIELD

The present disclosure relates to a device, a system, and a method for classifying vehicles via image analysis, and more specifically to, obtaining labeling information for classifying the vehicles using vehicle license plate recognition and vehicle registration information, and making a learning device learn the labeling information and a vehicle image together.

### BACKGROUND ART

Recently, fields and cases of analyzing images using deep learning and applying the same are rapidly increasing. In particular, the image analysis using the deep learning is widely utilized in a field of collecting and analyzing traffic information in a public sector.

The deep learning requires a large amount of data sets, and each image needs to generate a label suitable for a purpose thereof In particular, in order to classify types of vehicles, there are difficulties in that images of 2,000 or more types of vehicles should be classified and secured, and an appropriate amount of data should be secured for each type of vehicle.

In this specification, the type of vehicle means all classification information that may classify the vehicles. For example, vehicle registration information (information in FIG. 3) managed by a government agency (Ministry of Land, Infrastructure and Transport) may correspond to the type of vehicle, and the type of vehicle may be composed of a combination of one or more of the vehicle registration information.

The vehicle registration information means information listed on a vehicle registration certificate. In order for the vehicle to travel on a road, the government agency (Ministry of Land, Infrastructure and Transport) registers and manages vehicle information. The vehicle registration information stores a lot of information such as a vehicle registration number (commonly referred to as a vehicle number), a vehicle type, a use, a vehicle name, a model type and year, a vehicle identification number, an owner, a vehicle specification, and the like.

For example, when classifying the types of vehicles using the “vehicle names” of the vehicles by analyzing the images of the vehicles (that is, when the “vehicle types” to be sorted/classified are the “vehicle names”), in a case illustrated in FIG. 2 of the present disclosure, in order to distinguish the vehicle name (e.g., LF SONATA), numerous (thousands of) images of vehicles of the same vehicle name (i.e., the LF SONATA) were obtained and utilized to distinguish the vehicle name.

In one example, the “vehicle type” in the vehicle registration information is information obtained by classifying the vehicles based on a size. In current vehicle registration information, the vehicle types are classified into 9 types (a small passenger vehicle, a small van, a small truck, a medium passenger vehicle, a medium van, a medium truck, a large passenger vehicle, a large van, and a large truck).

Such information on the vehicle type is highly useful for vehicle toll collection (a parking lot and a highway), traffic restriction (a highway passage method), and investigation (model information of a vehicle that has passed without license plate information). However, until now, there is no way to solve a problem of an increase of existing vehicles and new vehicles.

In addition, various types of vehicle image filming devices and vehicle number reading devices are already in operation in local governments and related organizations (e.g., the Korea Expressway Corporation) in Korea. A system that may perform labeling based on a type of vehicle having a difference in appearance with respect to the existing vehicle and the newly released vehicle in association with the vehicle registration information described above using the vehicle image and the vehicle license plate information, may efficiently develop an algorithm using such labeling, and may be upgraded quickly is required.

### DISCLOSURE

### Technical Problem

The present disclosure is proposed to solve the problem described above. For label information for learning a vehicle image, vehicle registration information and the vehicle image are to be input. Via the input, it is to significantly increase accuracy of vehicle recognition and detection using the vehicle image. In addition, although a labeling work via human intervention has been mainstream to provide learning data in the prior art, it is to assign the label information by a device or a system without the human intervention in the present disclosure.

Problems to be solved in the present disclosure are not limited to the problems above, and other problems not mentioned will be clearly understood by those of ordinary skill in the technical field to which the present disclosure belongs from the description below.

### Technical Solutions

According to one embodiment of the present disclosure, a device for classifying vehicles via image analysis is proposed. The device includes image acquisition unit for acquiring a vehicle image containing a license plate of a vehicle, vehicle information acquisition unit for extracting vehicle identification information from the acquired vehicle image, registration information acquisition unit for acquiring vehicle registration information corresponding to the vehicle identification information, a control unit that selectively extracts a portion of the vehicle registration information indicating outer appearance characteristics of the vehicle and allocate a classification key thereto, and classifies the vehicle image based on the classification key, and a learning processing unit that learns the vehicle image using the classification key.

Additionally or alternatively, the vehicle registration information may include at least one of a vehicle registration number, a vehicle type, a vehicle name, a model type and year, a vehicle identification number, and a vehicle specification.

Additionally or alternatively, the vehicle identification information may include an identifier or a media access control (MAC) address of communication unit installed in the vehicle.

Additionally or alternatively, the registration information acquisition unit may additionally acquire outer appearance information of the vehicle based on at least one of a vehicle type, a vehicle name, a model type and year, and a vehicle identification number included in the vehicle registration information.

Additionally or alternatively, the control unit may include a storage for storing the vehicle image using a predetermined classification key or vehicle registration number as an index.

Additionally or alternatively, the learning processing unit may extract learning information by analyzing vehicle images corresponding to the same classification key.

Additionally or alternatively, the vehicle image input to the learning processing unit may contain a vehicle region extracted from the vehicle image using coordinates of the vehicle license plate.

According to another embodiment of the present disclosure, a system for classifying vehicles via image analysis is proposed. The system includes a vehicle classification device and an operation unit, the vehicle classification device includes image acquisition unit for acquiring a vehicle image containing a license plate of a vehicle, vehicle information acquisition unit for extracting vehicle identification information from the acquired vehicle image, registration information acquisition unit for acquiring vehicle registration information corresponding to the vehicle identification information, a control unit that selectively extracts a portion of the vehicle registration information indicating outer appearance characteristics of the vehicle and allocate a classification key thereto, and classifies the vehicle image based on the classification key, and a learning processing unit that learns the vehicle image using the classification key, and the operation unit classifies vehicle types of the vehicles using classification keys re-adjusted via re-adjustment for integrating or separating the classification keys based on a purpose of usage.

Additionally or alternatively, the operation unit may determine whether the vehicle registration information acquired corresponding to the vehicle identification information is different from vehicle information directly acquired from the vehicle image, and the directly acquired vehicle information may be acquired using data learnt by the learning processing unit.

Additionally or alternatively, the operation unit may determine whether there is a duplicated vehicle registration number among previously stored vehicle images and classification keys.

According to another embodiment of the present disclosure, a method for classifying vehicles via image analysis is disclosed. The method includes acquiring a vehicle image containing a license plate of a vehicle, extracting vehicle identification information from the acquired vehicle image, acquiring vehicle registration information corresponding to the vehicle identification information, selectively extracting a portion of the vehicle registration information indicating outer appearance characteristics of the vehicle and allocating a classification key thereto, and classifying the vehicle image based on the classification key, and learning the vehicle image using the classification key.

The technical solutions are only some of embodiments of the present disclosure. Various embodiments in which the technical features of the present disclosure are reflected may be derived and understood by those of ordinary skill in the art based on the detailed description of the present disclosure to be described in detail below.

### Advantageous Effects

According to the present disclosure, the label information for the vehicle recognition and the vehicle information acquisition may be efficiently acquired from the vehicle images using the vehicle registration information, thereby significantly reducing a time and a cost for the labeling.

In addition, according to the present disclosure, even when the new vehicle is released, the learning may be available by providing learning data quickly.

In addition, according to the present disclosure, the vehicle classification based on the usage or the purpose may become available based on the learning result.

The effects that may be obtained from the present disclosure are not limited to the effects mentioned above, and other effects not mentioned will be clearly understood by those of ordinary skill in the technical field to which the present disclosure belongs from the description below.

### Description of Drawings

The accompanying drawings, which are included as a portion of the detailed description to help understand the present disclosure, provide an embodiment of the present disclosure, and illustrate the technical idea of the present disclosure together with the detailed description.

FIG. 1 shows an overall configuration of a traffic control system related to the present disclosure.

FIG. 2 shows a result of acquiring vehicle information from a vehicle image.

FIG. 3 shows a vehicle registration certificate (registration information) related to the present disclosure.

FIG. 4 shows a block diagram of a device or a system related to the present disclosure.

FIG. 5 shows a procedure of setting a classification key from a vehicle image related to the present disclosure.

FIG. 6 shows a flowchart for vehicle license plate forged-vehicle detection related to the present disclosure.

FIG. 7 shows a flowchart of a label information acquisition and learning procedure for a vehicle in a vehicle image utilizing a classification key related to the present

FIG. 8 shows a vehicle image related to the present disclosure.

FIG. 9 shows a vehicle image related to the present disclosure.

### BEST MODE

Hereinafter, an embodiment of the present disclosure will be described with reference to the accompanying drawings. However, the present disclosure is not limited to the embodiment described in this specification and is able to be implemented in various other forms. The terminology used in this specification is intended to help the understanding of the embodiment, and is not intended to limit the scope of the present disclosure. In addition, singular forms used hereinafter include plural forms unless the phrases clearly indicate the opposite.

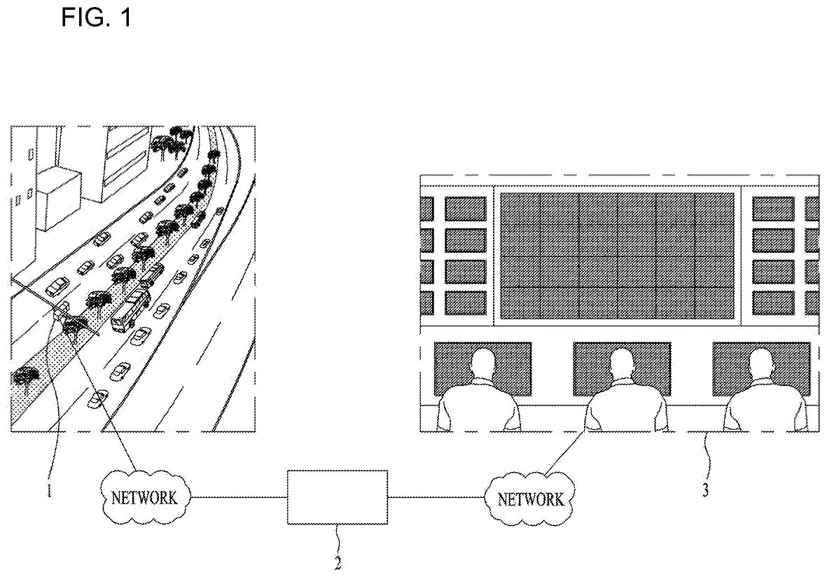

FIG. 1 shows an overall configuration of a traffic control system in a field to which the present disclosure belongs. The system may include an image acquisition device 1 such as a camera for acquiring an image by filming a traffic condition and adjunct devices related thereto, a server 2 connected to the image acquisition device in a wired or wireless manner, and a control system 3 such as a traffic control room operated by various local governments, the Korea Expressway Corporation, the Facilities Corporation, the National Police Agency, and the like. The image acquisition device may operate in association with means (e.g., at least one of an electromagnetic sensor, a radar sensor, and an image sensor) for detecting a vehicle such as a vehicle detection sensor. A device, a system, and the like according to the present disclosure may be included in one of the components shown in FIG. 1 or may exist as a separate device, system, or the like.

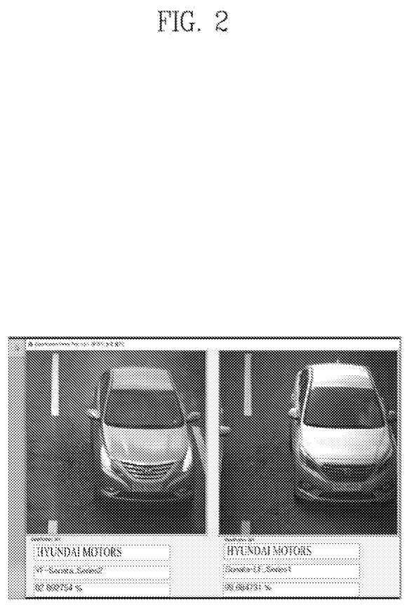

FIG. 2 shows a result of acquiring vehicle information from a vehicle image.

Left and right sides in FIG. 2 respectively show cases of analyzing an LF Sonata vehicle and a YF Sonata vehicle. Previously, for classification of such vehicle types, vehicles of the same type as a corresponding vehicle were visually read from numerous vehicle images to form thousands of data sets, and the data sets were learned to achieve the classification.

Because it takes a year or more for such previous scheme to construct an algorithm for classifying 850 types of vehicles by collecting the vehicle images, labeling the vehicle images, and forming the data sets, it was practically impossible to quickly update the algorithm to keep pace with a speed of release of new vehicles.

It is practically impossible to collect vehicle images of vehicles of 2,000 types or more previously registered in Korea and classify types of vehicles in such method. In particular, in a case of a type of vehicles with a small number of registered vehicles and vehicles scattered across the country, it is difficult to secure data of an amount required for learning of the vehicle images, so that it is difficult to construct a reliable algorithm.

In addition, in recent years, in a situation in which the release of the new vehicles such as electric vehicles, hydrogen vehicles, and the like from internal combustion engine vehicles continues, a supply of vehicles is not much, but types of the vehicles are increasing. Thus, a development of the algorithm that analyzes the type of vehicle using the vehicle image is becoming more difficult.

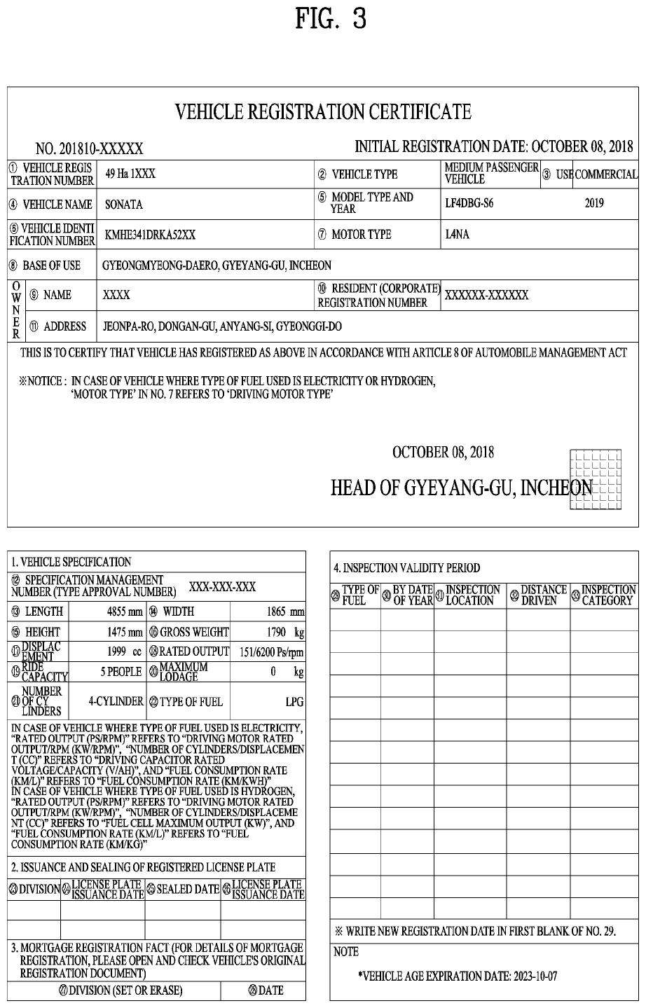

FIG. 3 shows a vehicle registration certificate (registration information) related to the present disclosure.

The government stipulates in Article 5 of the Vehicle Management Act such that the vehicle may be registered and operated. FIG. 3 is a copy of a vehicle registration certificate.

FIG. 3 will be described. Information contained in the “vehicle registration certificate” includes 28 items and a registration date, so that a total of 29 items are registered. However, vehicle registration information managed by the government contains more information about the vehicle than contents described in the “vehicle registration certificate” provided to a vehicle owner.

In the vehicle registration information and in the vehicle registration certificate distributed to the vehicle owner, “vehicle-related matters” include vehicle information such as a vehicle registration number (a vehicle number), a vehicle type, a vehicle name, a model type and year, a vehicle identification number, and the like, and “owner-related matters” include a name, an address, a resident registration number. Further, the vehicle registration information includes “vehicle specification”, and the like.

In one example, the vehicle registration information included in the vehicle registration certificate shown in FIG. 3 may be stored and managed in a separate database operated by the government. A vehicle classification device according to the present disclosure to be described later may receive the vehicle registration information stored in database of the government. In addition, a vehicle manufacturer database may store various vehicle information (a vehicle color, an engine type, and the like) corresponding to the model type and year and the vehicle identification number among the vehicle registration information, and the vehicle classification device according to the present disclosure to be described later may receive the information stored in the vehicle manufacturer database.

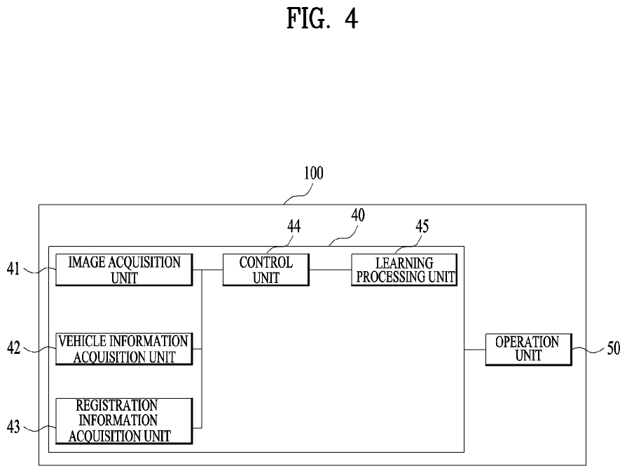

FIG. 4 shows a block diagram of a device 40 and a system 100 related to the present disclosure.

The vehicle classification system 100 according to an embodiment of the present disclosure may include a vehicle classification device 40 and an operation unit 50.

The vehicle classification device 40 according to an embodiment of the present disclosure may include image acquisition unit 41, vehicle information acquisition unit 42, registration information acquisition unit 43, a control unit 44, and a learning processing unit 45.

The image acquisition unit 41 may acquire a vehicle image containing a vehicle license plate. Usually, the vehicle images have a difference in an angle of view depending on an angle and a distance based on a type used in road traveling or a parking lot, and contain a license plate region of the vehicle. Based on a name of the information in the vehicle registration certificate, a number, a character, and the like recorded in the license plate region of the vehicle will be referred to as a “vehicle registration number” or simply a “registration number” in this specification.

In the vehicle image acquired or received in the present disclosure, the license plate region or a passenger region of the vehicle is detected. In order for personal information protection, it is preferable to precede masking for the personal information protection, such as replacing, blurring, or the like of an image of the corresponding region.

In addition, identification of the vehicle in the vehicle image is basically performed via the detection and recognition of the license plate region of the vehicle, but this is not necessarily the case. An image of a vehicle that is proven to be the same vehicle as a vehicle in a vehicle image from which a specific vehicle registration number is acquired may be used as the vehicle image in the present disclosure even when a vehicle license plate is not contained therein. For example, in a situation in which a camera for filming a front face of the vehicle and a camera for filming a side face of the vehicle are installed at the same time, in a case of a front image containing the license plate of the vehicle and a side image not containing the license plate of the vehicle, when the vehicles in the front and side images are recognized as the same vehicle, the side image may also be included in the vehicle image according to the present disclosure.

The vehicle information acquisition unit 42 may acquire vehicle identification information from the acquired vehicle image. The vehicle identification information may include not only the vehicle registration number, but also information capable of identifying the vehicle as mentioned above.

The vehicle identification information includes a vehicle registration number in a form of text extracted using a vehicle number recognition algorithm for the vehicle license plate contained in the vehicle image, and in particular, must be completely configured to fit a vehicle registration number configuration system.

The configuration system of the vehicle registration number in Korea will be briefly described. A license plate with a white background is in a form of “112 Ga 1234”, and should be composed of 2 to 3 digits indicating which type the corresponding vehicle is among a passenger vehicle, a van, a truck, and a special vehicle (assigned with 100-699, 70-79, 80-97, and 98-97, respectively), a usage symbol hangul (one character), and a 4-digit serial number (0000 to 9999).

A license plate with a yellow background color is in a form of “Seoul 70 Ba 1234”, and should include a name of a region (“Seoul”) at the beginning The usage symbol Hangul includes at least one of “Ba”, “Sa”, “A”, and “Ja”.

In the present disclosure, the vehicle registration number that is completely configured to fit the vehicle registration number configuration system is uniquely present in the vehicle registration information, and is able to specify the vehicle.

In order to recognize the vehicle identification information, in particular, the vehicle registration number (recorded on the vehicle license plate) in the vehicle image, coordinates of the vehicle license plate may be used. Thus, for efficient learning in the learning processing unit 45 to be described later, the vehicle information acquisition unit 42 may detect, recognize, or extract various regions of the vehicle based on the vehicle license plate, or may detect, recognize, or extract only a vehicle region within the vehicle image. This is because the vehicle image contains the vehicle, a road, a lane, a passenger, or various background images.

In particular, when the vehicle image described above is obtained by filming the front face of the vehicle, because the passenger region contains objects unnecessary for the learning caused by a passenger, an object attached to a dashboard, or the like, in order to increase a learning effect, the learning may be performed by excluding a windshield from the front face of the vehicle.

To this end, the vehicle information acquisition unit 42 may extract a region of the vehicle based on a position of the license plate using the position coordinates of the vehicle license plate contained in the vehicle image.

In addition, the vehicle identification information may include an identifier (ID) or a media access control (MAC) address of communication unit mounted on the vehicle.

The registration information acquisition unit 43 may acquire the vehicle registration information corresponding to the vehicle identification information. The vehicle registration information may include at least one of the vehicle registration number, the vehicle type, the vehicle name, the model type and year, the vehicle identification number, and the vehicle specification.

The vehicle registration information described in the vehicle registration certificate in FIG. 3 will be described. A vehicle registration number “49 Ha 1XXX” may include vehicle registration information such as a vehicle type of “medium passenger vehicle”, a use of “commercial”, a vehicle name of “SONATA”, a model type and year of “LF4DBG-S6 2019”, and the like. Accordingly, the vehicle registration information may be acquired using the vehicle identification information.

In addition, when using the model type and year (“LF4DBG-S6 2019”), the registration information acquisition unit 43 may acquire useful information (e.g., the vehicle color information and the engine type) provided by a vehicle manufacturer. In this item, information about a difference in an outer appearance of the vehicle may be acquired. That is, additional information of the vehicle in association with or included in the information such as the model type and year, the vehicle identification number, or the like in the vehicle registration information may also be acquired. In this specification, it is assumed that the additional information is also included in the vehicle registration information.

In one example, registration information of the vehicle of interest in the present disclosure is registration information of the vehicle that may classify vehicles with different outer appearance characteristics. Therefore, a classification key, which will be described later, may be generated using at least one item (e.g., the vehicle name and the like) that may distinguish the vehicles having the different outer appearance characteristics in the above-described various vehicle registration information.

In addition, when the vehicle identification information includes the identifier (ID), the MAC address, or the like of the communication unit mounted on the vehicle, the registration information of the vehicle may be acquired using the ID or the MAC address of the communication unit.

In one example, information that violates the Personal Information Protection Act in various information included in the vehicle registration information should be excluded in relation to the present disclosure. Accordingly, owner information of the vehicle may be excluded from the registration information of the vehicle.

The control unit 44 may generate the classification key using at least a portion of the vehicle registration information of vehicles having a difference in the outer appearance on the vehicle images, and classify the vehicle images based on the generated classification key. In this regard, the classification key refers to vehicle classification information (e.g., the vehicle type, the vehicle name, the model type and year, and the like) in association with at least one outer appearance characteristic of the vehicle that may be recognized or detected in the vehicle image. Accordingly, when, for example, there are outer appearance characteristics of two vehicles (referred to as A and B, respectively), or when these two are used to generate the classification key, a classification key K_{AB} corresponding to a combination of A and B may be generated. Vehicle images of vehicles having the same outer appearance characteristics (A, B) may all be allocated with the same classification key K_{AB} and may be classified accordingly.

For example, assuming that newly released vehicles have the same vehicle name “KS_SONATA” and there are two “model type and year”s of “ABCD-1 2019” and “ABCD-2 2019”, in the present disclosure, different classification keys may be set for the respective “model type and year” when there are the difference in the outer appearance characteristics of the two vehicles, or the same classification key may be set for the two “model type and year”s when the outer appearances of the two vehicles are the same. The classification key setting may be rationally performed in a step of constructing an algorithm by subdividing the outer appearances and classifying the subdivided outer appearances.

In addition, the color information of the vehicle may be subdivided such that whether to apply the classification key may be determined selectively based on a purpose (e.g., toll collection, police/prosecution investigation, and the like) of using results of the image analysis and the learning according to the present disclosure.

Therefore, such selection of the classification key may be performed such that the classification key is generated using a “model type and year” of the newly released vehicle, and in a case of information of vehicles that are previously released to have the same “model type and year”, but have the difference in the outer appearance, the classification key is generated and set additionally using the “vehicle identification number” or the like.

The “vehicle type”, the “vehicle name”, and the “model type and year” among the above-described multiple vehicle registration information elements may be applied to the classification key (e.g., “passenger vehicle_SONATA_ABCD-1_2019”), and the classification key to which the “vehicle type”, the “vehicle name”, and the “model type and year” are applied may classify vehicle images of vehicles having the same “vehicle type”, “vehicle name”, and “model type and year” and may be provided to the learning processing unit 45 to be described later.

It is preferable to generate or set such a classification key by selectively extracting the items included in the vehicle registration information. For example, the classification key may contain the “manufacturer”, the “vehicle name”, and the “model type and year” by default. The “manufacturer” may be information that may be acquired from the “vehicle name” or other information among the vehicle registration information.

The vehicle classification algorithm according to the present disclosure may be variously used in the toll collection, the investigation, transportation information collection, and the like based on the purpose of usage. Rather than developing an algorithm suitable for each purpose of usage, it is desirable to construct a subdivided classification algorithm and integrate and separate the classification keys based on the purpose of usage. That is, in the same manner as the classification key may indicate the outer appearance characteristics, or the coupling or the combination thereof as described above, the classification keys may be subdivided or integrated with each other based on the purpose of usage.

In one example, it may be additionally considered that the control unit 44 may generate the classification key and perform indexing capable of classifying and storing the vehicle images or calling an existing vehicle image using the classification key. That is, the control unit 44 may store the acquired vehicle images after indexing the vehicle images with the generated classification key, and may use the corresponding classification key when calling the vehicle image in the future.

In addition, a process for a vehicle that is previously registered and traveled and a process for a new vehicle may be roughly the same with each other, but may have a difference in details.

The learning processing unit 45 may learn the vehicle images using the generated classification key. In addition, the learning processing unit 45 may learn the vehicle images and the generated classification key. The learning processing unit 45 may extract characteristic information of the vehicle contained in the vehicle image, and more specifically, the control unit 44 may extract characteristics of the vehicle images classified by the classification key (e.g., the “passenger vehicle SONATA_ASCD-A_2019”). That is, the learning processing unit 45 may extract learning information by analyzing the vehicle images corresponding to the same classification key.

For example, shapes of front faces of Hyundai's “Sonata” and Kia's “K5” have many differences even when viewed with the human eye, so that characteristic information such as a bumper, a grille, a light, an emblem, an entire front face contour, and the like may be extracted centering on the license plate region of the front face of the vehicle. As characteristics that allow the vehicles to be classified in the front images of the vehicles, there are the biggest differences in the grilles, the lights, and the emblems. The algorithm that extracts characteristics of each of such elements, combines the characteristics, and classifies the vehicles may be constructed.

In one example, recently, an algorithm for recognition and classification using deep learning may analyze, even when a region of a portion where the difference in the vehicle outer appearance is clear in the vehicle image is not artificially specified by human, the difference.

However, it may be necessary to set a detailed portion for efficiency of the algorithm, but the present disclosure may not be limited thereto.

The learning processing unit 45 may use the location coordinates of the vehicle license plate contained in the vehicle image acquired by the vehicle information acquisition unit 42 to extract and learn a region of the vehicle based on the position of the license plate, or to extract and learn the detailed characteristic information from only a specific region (e.g., the grille, the light, and the emblem) of the vehicle more specifically.

In addition, as described above, the image (an image obtained by filming a rear portion, a side face, and a roof of the vehicle), which does not contain a license plate, of the vehicle that is proven to be the same vehicle as the vehicle in the vehicle image containing the vehicle number may also be learned at the same time. In addition, as will be described later, in order to classify the vehicle types based on a highway toll system, it is necessary to be able to detect the number of axles of the vehicle. The learning processing unit 45 may extract the characteristic information using an image for detecting the number of vehicle axles from the side, the rear, or the like to extract the number of axles, a wheel track, a wheel width, and the like of the vehicle.

The operation unit 50 may include a database for classifying the vehicle types via readjustment of integrating or separating the classification keys based on the purpose of usage. The operation unit 50 may be communicatively connected to the vehicle classification device 40 via a wired or wireless network.

The database may integrate and classify the vehicle types into six types using, for example, thousands of classification keys and the characteristic information of the vehicle outer appearance based on the highway toll system, and may classify the vehicle types into the passenger vehicle, the van (medium, large), the truck (small, medium, large), and the like based on the purpose of use.

In one example, for tolling based on the toll system, a “vehicle type classification device” is used, and such device classifies the vehicles into 6 types using the information on the number of axles, the wheel width, and the wheel track of the vehicle. Table 1 below is a vehicle type classification table.

TABLE 1

| | Vehicle type | Applied |
|---|---|---|
| Vehicle type | classification criteria | vehicle (example) |
| Class 1 | 2-axle vehicle, wheel width | Passenger vehicle, |
| (small vehicle) | 279.4 mm or smaller | small van, |
| | | small truck |
| Class 2 | 2-axle vehicle, wheel width | Medium van, |
| (medium vehicle) | exceeding 279.4 mm, wheel | medium truck |
| | track 1,800 mm or smaller | |
| Class 3 | 2-axle vehicle, wheel width | Large van, 2-axle |
| (large vehicle) | exceeding 279.4 mm, wheel | large truck |
| | track exceeding 1,800 mm | |
| Class 4 | 3-axle large truck | |
| (large truck) | | |
| Class 5 | Special truck with 4 or | |
| (special truck) | more axles | |
| Class 1 | Length 3.6 m, width 1.6 m, | |
| (light vehicle) | height 2.0 m or smaller | |
| | with displacement of | |
| | smaller than 1000 cc | |

In general, in order to generate the vehicle information, a treadle sensor is installed on a road surface, and the vehicle information is collected via contact with the wheels of the traveling vehicle. Because of the contact scheme, damage occurs and a cost for maintenance increases over time. An attempt is made to classify the “vehicle types” using the vehicle image to replace such a sensor of the physical contact scheme. In order to detect the number of vehicle axles, the image for detecting the number of vehicle axles from the side may be additionally acquired, or the vehicle may be diagonally filmed to acquire a single vehicle image and the image may be analyzed.

In one example, even in this case, as long as the vehicle registration number may be acquired via the vehicle image analysis and the vehicle registration information (the contents contained in the vehicle registration certificate) corresponding to the corresponding vehicle registration number may be acquired, the additional vehicle images such as side and rear images other than the vehicle image containing the vehicle license plate may not be necessary.

In addition, the operation unit 50 may detect an abnormal vehicle using the vehicle registration information. In this regard, the operation unit 50 may determine whether the vehicle registration information acquired corresponding to the vehicle identification information and the vehicle information directly acquired from the vehicle image are different from each other.

In addition, the operation unit 50 may determine whether there is a duplicated vehicle registration number among the previously stored vehicle images and classification keys. This is to detect a vehicle that is operating with the same vehicle license plate attached, that is, a vehicle license plate forged-vehicle.

To this end, vehicle registration management means that acquires and analyzes information about registration and erasure of a target vehicle and owner change information may be additionally included in the operation unit 50.

Through the above, in order to develop a device, a system, and a method for classifying and analyzing the vehicles using the existing vehicle images, a process of collecting a large number of vehicle images for the vehicles of the same type, forming the data sets by labeling the vehicle images, and learning the data sets may be configured such that automatic labeling, data set formation, and learning of the data sets are achieved using the vehicle registration information.

Therefore, the vehicle classification and analysis algorithm will be able to be developed corresponding to the newly released vehicle, and an algorithm that analyzes a type of a vehicle currently registered will be able to be developed.

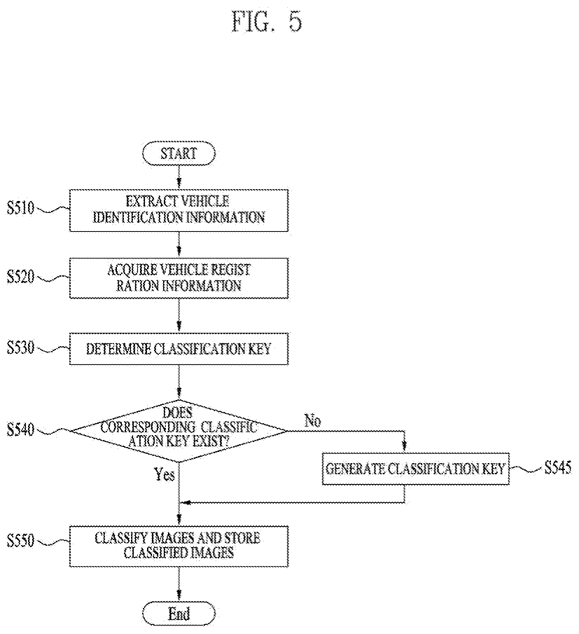

FIG. 5 shows a procedure of setting a classification key from a vehicle image related to the present disclosure. The procedure in FIG. 5 may be performed by the vehicle classification device 40 according to the present disclosure.

The vehicle identification information may be extracted from the vehicle image (S510). The vehicle identification information may include not only the vehicle registration number, but also the information capable of identifying the vehicle as described above. In addition, the vehicle identification information may include the identifier (ID), the MAC address, or the like of the communication unit mounted on the vehicle.

The vehicle registration information may be acquired using the acquired vehicle identification information (S520). The vehicle registration information may include at least one of the vehicle registration number, the vehicle type, the vehicle name, the model type and year, the vehicle identification number, and the vehicle specification required for the vehicle registration. In addition, the vehicle registration information may include the outer appearance characteristics of the vehicle additionally acquired from the various vehicle registration information described above.

The classification key may be determined from the vehicle registration information (S530).

Whether the same classification key as the determined classification key exists may be determined (S540). When the same classification key as the determined classification key already exists, the corresponding vehicle image may be stored together with the corresponding classification key or information on the corresponding classification key (S550). In this regard, the stored vehicle image may be indexed with the corresponding classification key, and may be called via the indexing when the vehicle image is called in the future.

When there is no classification key corresponding to the vehicle registration information, the determined classification key may be generated (S545). Then, the corresponding image may be stored together with the generated classification key (S550).

In the procedure described in relation to FIG. 5, data acquired or prepared in each step are expressed as follows.

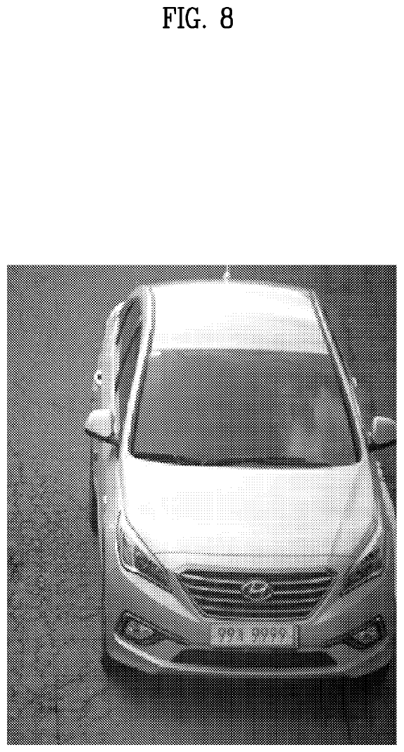

As a result of S510, the vehicle image and the vehicle registration number may be matched with each other as shown in Table 2 below and FIG. 8.

The vehicle registration information acquired via S520 may be as shown in Table 3 below.

TABLE 3

| Vehicle identification | Vehicle registration information | | | | |
|---|---|---|---|---|---|
| information (vehicle | | | | | Vehicle |
| registration number) | Vehicle type | Manufacturer | Vehicle name | Model type and year | Specification |
| 49 Ha 1XXX | Passenger vehicle | Hyundai | SONATA | LF4DBG-S6 2019 | . . . |
| | | | (LF SONATA) | | |

Examples of the classification keys mentioned in S530 to S545 are shown in Table 4 below and FIG. 8.

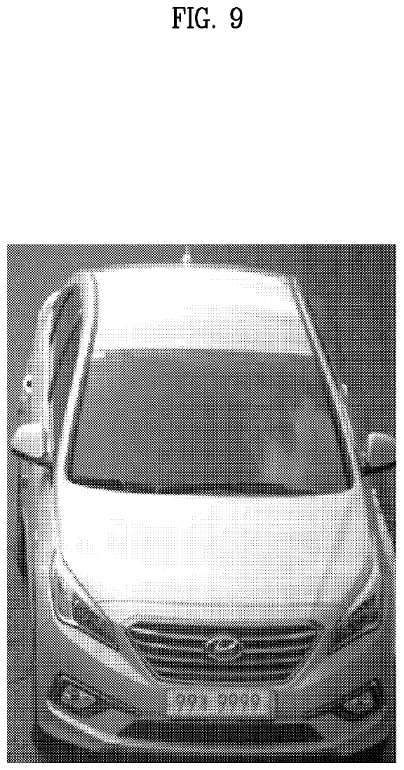

The classification key and the vehicle image are stored as follows, and the classification key and the vehicle image are the data set that is a learning target of the learning processing unit 45. The vehicle image in FIG. 9 that is cited in Table 5 is an image excluding a background region from an original vehicle image.

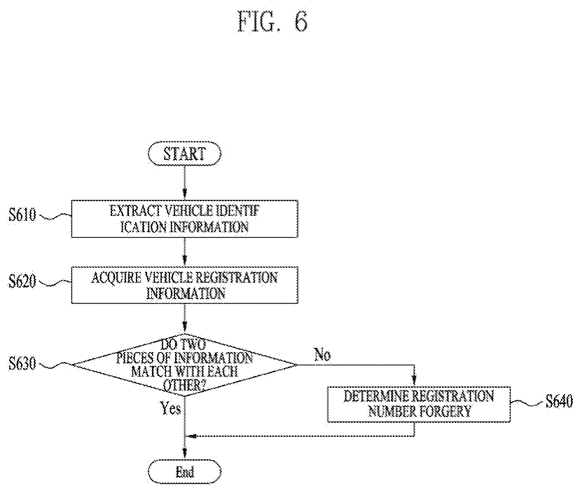

FIG. 6 shows a flowchart for vehicle license plate forged-vehicle detection related to the present disclosure. FIG. 6 may be performed by the vehicle classification device 40 or the operation unit 50 according to the present disclosure.

The vehicle identification information may be extracted from the vehicle image (S610). The vehicle identification information may include not only the vehicle registration number, but also the information capable of identifying the vehicle as described above. In addition, the vehicle identification information may include the identifier (ID), the MAC address, or the like of the communication unit mounted on the vehicle. In one example, the vehicle image may be acquired from the image acquisition unit 41 or the image acquisition device 1 of the traffic control system.

The vehicle registration information may be acquired using the acquired vehicle identification information (S620). The vehicle registration information may include at least one of the vehicle registration number, the vehicle type, the vehicle name, the model type and year, the vehicle identification number, and the vehicle specification. In addition, the vehicle registration information may include the outer appearance characteristics of the vehicle additionally acquired from the various vehicle registration information described above.

Then, whether the vehicle registration information and the vehicle information directly acquired from the vehicle image match with each other or are different from each other may be determined (S630). To this end, procedures such as object recognition, analysis, and the like for the vehicle image may be performed, and data learnt by the learning processing unit 45 may be used for the same.

When the vehicle registration information and the vehicle information directly acquired from the vehicle image match with each other, a vehicle license plate forgery detection procedure is terminated.

When the vehicle registration information and the vehicle information directly acquired from the vehicle image do not match with each other, for example, when a vehicle number 49 Ha 1XXX is registered as Sonata in the vehicle registration information, but a vehicle of the same vehicle number is Grandeur in the directly acquired vehicle information, this may be determined as a vehicle license plate forgery (S640), corresponding information may be transmitted to the police, the local governments, and the like, and such information may be used in illegal vehicle control or the like. In this regard, the transmission of the corresponding information to the police, the local governments, and the like may be performed by the operation unit 50.

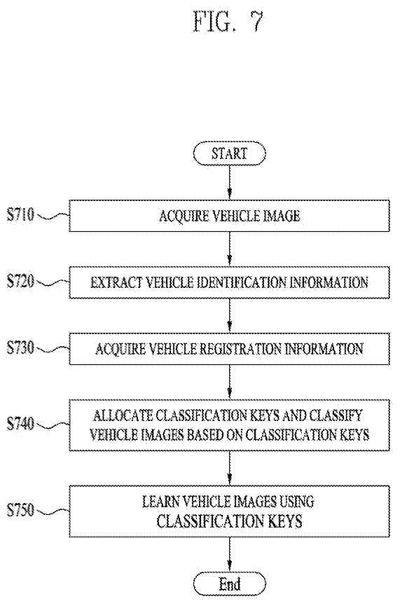

FIG. 7 shows a flowchart of a label information acquisition and learning procedure for a vehicle in a vehicle image utilizing a classification key related to the present disclosure. The label information acquisition and learning procedure may be performed by the vehicle classification device 40 via the image analysis, and this will be described with reference to FIG. 7. However, the above-described contents not described with reference to FIG. 7 may also be performed by the device 40.

The device may acquire the vehicle image containing the vehicle license plate (S710). The vehicle image may be filmed by the image acquisition unit.

The device may extract the vehicle identification information from the acquired vehicle image (S720). The vehicle identification information may include the vehicle number (the vehicle registration number on the vehicle registration certificate), and may include information (referred to as “other information”) on the outer appearance characteristics of the vehicle. In addition, the vehicle identification information may include the identifier or the MAC address of the communication unit installed on the vehicle. In this regard, it is preferable that the outer appearance characteristic information of the vehicle and the identifier or the MAC address may be associated with each other.

The device may acquire the vehicle registration information corresponding to the vehicle identification information (S730). The vehicle registration information may include at least one of the vehicle registration number, the vehicle type, the vehicle name, the model type and year, the vehicle identification number, and the vehicle specification required for the vehicle registration. That is, the vehicle registration information includes information related to the vehicle indicated in the vehicle registration certificate.

The device may additionally acquire the outer appearance information of the vehicle in the vehicle image based on at least one of the vehicle type, the vehicle name, the model type and year, and the vehicle identification number contained in the vehicle registration certificate.

The device may allocate the classification keys using at least a portion of the vehicle registration information indicating the outer appearance characteristics in the vehicle images, and may classify the vehicle images based on the classification keys (S740). The apparatus may include a storage for storing the vehicle image using a predetermined classification key or vehicle registration number as the index.

Then, the device may learn the vehicle images using the classification keys (S750). The device may extract the learning information by analyzing the vehicle images corresponding to the same classification key. In this regard, the learning means receiving the vehicle image and the classification key so as to extract the characteristics in the vehicle image, and matching the extracted characteristics with the classification key or information indicated by the classification key. Therefore, even when the vehicle registration number of the vehicle license plate in the vehicle image is not used in the future, the vehicle in the vehicle image may be detected and recognized via the outer appearance characteristics of the vehicle, and the learning is performed to increase reliability, accuracy, or the like of the detection and the recognition of the vehicle. The vehicle image for the learning may contain the vehicle region extracted from the vehicle image using the coordinates of the vehicle license plate.

The device may be in association with the operation unit including the database for classifying the vehicle types via the readjustment of integrating or separating the classification keys based on the purpose of usage. For the integration and the separation of the classification keys, refer to the description above.

In addition, for crackdown on the vehicle license plate forgery or the like, the operation unit may determine whether the vehicle registration information acquired corresponding to the vehicle identification information is different from the vehicle information directly acquired from the vehicle image, and the directly acquired vehicle information may be acquired using the data learnt by the learning processing unit.

In addition, the operation unit may determine whether there is the duplicated vehicle registration number in the previously stored vehicle image and classification key sets. The device may include the storage for storing the vehicle image and the classification key, and the operation unit may acquire the stored vehicle image and classification key from the device, or may store the acquired vehicle image and classification key in the database after the acquisition.

In the above specification, the “device” or the “system” and the components thereof (the image acquisition unit 41, the vehicle information acquisition unit 42, the registration information acquisition unit 43, the control unit 44, the learning processing unit 45, and/or the operation unit 50) have been described as performing the corresponding method, procedure, or the like, but the “device” and the components belonging thereto are names only, and the scope of rights is not subordinated thereto. That is, the corresponding method or procedure may be performed by the system or the like other than the device. In addition, the method or scheme may be performed by codes readable by software, computers, or other machines or devices for the vehicle image analysis.

In addition, as another aspect of the present disclosure, the operation of the above-described proposal or invention may be provided as codes that may be realized, implemented, or executed by the “computer” (a comprehensive concept including a system on chip (SoC), a (micro) processor, or the like), as a computer-readable storage medium storing or including the codes, or as a computer program product. The scope of the present disclosure is extendable to the codes, the computer-readable storage medium storing or including the codes, or the computer program product.

Detailed descriptions of preferred embodiments of the present disclosure disclosed as described above have been provided such that those skilled in the art may implement and practice the present disclosure. Although the description has been made with reference to the preferred embodiments of the present disclosure, it will be understood by those skilled in the art that the present disclosure described in the claims below may be variously modified and changed. Accordingly, the present disclosure is not intended to be limited to the embodiments shown herein, but is to be accorded the widest scope consistent with the principles and novel features disclosed herein.

1. A device for classifying vehicle images, the device comprising:
an image acquisition unit for acquiring a vehicle image containing a license plate of a vehicle;
a vehicle information acquisition unit for extracting vehicle identification information from the acquired vehicle image;
a registration information acquisition unit for acquiring vehicle registration information corresponding to the vehicle identification information;
a control unit configured to:
selectively extract a portion of the vehicle registration information indicating outer appearance characteristics of the vehicle and allocate a classification key thereto; and
classify the vehicle image based on the classification key; and
a learning processing unit configured to learn the vehicle image using the classification key.

2. The device of claim 1, wherein the vehicle registration information includes at least one of a vehicle registration number, a vehicle type, a vehicle name, a model type and year, a vehicle identification number, and a vehicle specification.

3. The device of claim 1, wherein the vehicle identification information includes an identifier or a media access control (MAC) address of communication unit installed in the vehicle.

4. The device of claim 1, wherein the registration information acquisition unit additionally acquires outer appearance information of the vehicle based on at least one of a vehicle type, a vehicle name, a model type and year, and a vehicle identification number included in the vehicle registration information.

5. The device of claim 1, wherein the controller includes a storage for storing the vehicle image using a predetermined classification key or vehicle registration number as an index.

6. The device of claim 1, wherein the learning processing unit is configured to extract learning information by analyzing vehicle images corresponding to the same classification key.

7. The device of claim 1, wherein the vehicle image input to the learning processing unit contains a vehicle region extracted from the vehicle image using coordinates of the vehicle license plate.

8. A system for classifying vehicle images, the system comprising:
a vehicle classification device configured to:
acquire a vehicle image containing a license plate of a vehicle;
extract vehicle identification information from the acquired vehicle image;
acquire vehicle registration information corresponding to the vehicle identification information;
selectively extract a portion of the vehicle registration information indicating outer appearance characteristics of the vehicle and allocate a classification key thereto;
classify the vehicle image based on the classification key; and
learn the vehicle image using the classification key; and
an operation unit configured to classify vehicle types of the vehicles using classification keys re-adjusted via re-adjustment for integrating or separating the classification keys based on a purpose of usage.

9. The system of claim 8, wherein the operation unit is configured to determine whether the vehicle registration information acquired corresponding to the vehicle identification information is different from vehicle information directly acquired from the vehicle image,
wherein the directly acquired vehicle information is acquired using data learnt by the learning processing unit.

10. The system of claim 8, wherein the operation unit is configured to determine whether there is a duplicated vehicle registration number among previously stored vehicle images and classification keys.

11. A method for classifying vehicle images, the method comprising:
acquiring a vehicle image containing a license plate of a vehicle;
extracting vehicle identification information from the acquired vehicle image;
acquiring vehicle registration information corresponding to the vehicle identification information;
selectively extracting a portion of the vehicle registration information indicating outer appearance characteristics of the vehicle and allocating a classification key thereto, and classifying the vehicle image based on the classification key; and
learning the vehicle image using the classification key.

12. The method of claim 11, wherein the acquiring of the vehicle registration information includes additionally acquiring outer appearance information of the vehicle based on at least one of a vehicle type, a vehicle name, a model type and year, and a vehicle identification number included in the vehicle registration information.

13. The method of claim 11, further comprising storing the vehicle image using a predetermined classification key or vehicle registration number as an index.

14. The method of claim 11, wherein the learning of the vehicle image includes extracting learning information by analyzing vehicle images corresponding to the same classification key.

15. The method of claim 11, wherein the vehicle image used for the learning contains a vehicle region extracted from the vehicle image using coordinates of the vehicle license plate.
